(19) United States
(12) Patent Application Publication
(10) Pub. No.: US 2025/0335159 A1
(43) Pub. Date: Oct. 30, 2025

(54) ARTIFICIAL INTELLIGENCE SYSTEM FOR DATA SOURCE DISCOVERY AND ACCESS

(71) Applicant: HITACHI, Ltd., Tokyo (JP)

(72) Inventors: Shoji YUNOKI, Santa Clara, CA (US); Takuya HABARA, Santa Clara, CA (US); Sudhanshu GAUR, Cupertino, CA (US)

(21) Appl. No.: 18/651,294

(22) Filed: Apr. 30, 2024

(51) Int. Cl. G06F 8/33; G06F 8/35

(52) U.S. Cl. CPC G06F 8/33; G06F 8/35; G06F 8/36

(57) ABSTRACT

Systems and methods described herein can involve, responsive to receiving a user request associated with an API type, retrieving a template from a template database; providing the template to a user to obtain a user-defined requirement; using the user-defined requirement to obtain from an API code creation database a historic requirement that is associated with the user-defined requirement and is associated with a source code; in response to the historic requirement being identical to the user-defined requirement, communicating an API endpoint to the user; in response to the historic requirement not being identical to the user-defined requirement, providing the user-defined requirement and the source code to a generative AI model to request an API source code; and in response to receiving the API source code and an endpoint name, communicating the endpoint name to the user.

### BACKGROUND

### Field

The present disclosure is generally directed to source code generation tools, and more specifically, to systems and methods that automatically generate source code for data retrieval Application Programming Interfaces (APIs) and similar tasks.

### Related Art

In recent years, there has been a movement towards enhancing operational efficiency through strategic use of data across various industries. For applications that harness data, data integration oftentimes requires accessing APIs. However, in instances where the required API is not available, a need arises to develop a new API for acquiring the required data. This absence of suitable APIs can sometimes lead to bottlenecks in the application development process. Leveraging services provided by generative Artificial Intelligence (AI) tools that incorporate natural language processing, such as advanced chat bots, users can generate source code for use in APIs to perform data acquisition tasks. Yet, improving the accuracy of the generated code remains a challenge. Accordingly, it is desirable to have systems and methods that can automatically generate source code for data retrieval APIs with a high degree of accuracy.

### SUMMARY

In some aspects of the disclosure, the generation of API source code for data retrieval tasks is streamlined by utilizing systems and methods that combine an API requirement template database with a code creation database to match user requirements to existing templates. Based on the match, generative AI can be used to generate new API source code from the ground up. The API requirement template database stores requirement templates that aid in creating user-defined templates designed for specific data retrieval APIs. In addition, the API code creation database stores source code of previously generated APIs and requirements associated therewith structured in the same format as the templates. The contents of user-defined templates are compared to the existing requirements stored in the API code creation database to find an existing template that most closely matches the user-defined template and its corresponding existing source code. Subsequently, the source code and the user-requirements are provided to an external program or generative AI to automatically generate the data retrieval API source code.

Aspects of the present disclosure can involve an automatic source code generation system, which can involve: a user interface that receives a user request associated with an API type; a template database that stored a template provided to a user to obtain a user-defined requirement; an API code creation database that, in response to receiving the user-defined requirement, provides a historic requirement associated with a historic source code and the user-defined requirement; and a generative AI model that, in response to receiving the user-defined requirement and the historic source code, generate an API source code that is then provided to a user.

Aspects of the present disclosure can involve a system, which can involve means for retrieving a template from a template database in response to receiving a user request associated with an API type; means for providing the template to a user to obtain a user-defined requirement; means for using the user-defined requirement to obtain from an API code creation database a historic requirement that is associated with the user-defined requirement and is associated with a source code; means for communicating an API endpoint to the user in response to the historic requirement being identical to the user-defined requirement; means for providing the user-defined requirement and the source code to a generative AI model to request an API source code in response to the historic requirement not being identical to the user-defined requirement; and means for communicating the endpoint name to the user in response to receiving the API source code and an endpoint name.

### BRIEF DESCRIPTION OF DRAWINGS

FIG. 1 illustrates an exemplary source code generation system in accordance with an example implementation.

FIG. 2A through FIG. 2C illustrate exemplary API requirement templates, in accordance with an example implementation.

FIG. 3A through FIG. 3C illustrate exemplary records in an exemplary API code creation database, in accordance with an example implementation.

FIG. 4 is a flowchart illustrating an exemplary process for using an API source code creation system, in accordance with an example implementation.

FIG. 5 depicts an exemplary table comprising user-defined requirements for an API, in accordance with an example implementation.

FIG. 6 depicts the contents of a message, in accordance with an example implementation.

FIG. 7 depicts an exemplary message generated by a generative AI module, in accordance with an example implementation.

FIG. 8 is a flowchart illustrating a generalized process for using an API source code creation system, in accordance with an example implementation.

FIG. 9 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations. In this document, the terms “template” and “table” are used interchangeably. Similarly, the terms “existing” and “historic” are used interchangeably.

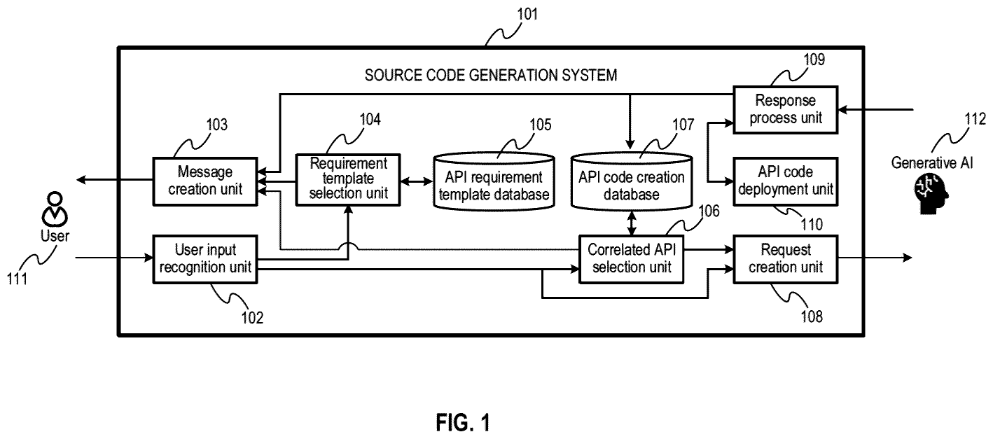

FIG. 1 illustrates an exemplary source code generation system in accordance with an example implementation. In embodiments, source code generation system 101 comprises message creation unit 103, requirement template selection unit 104, API requirement template database 105, correlated API selection unit 106, API code creation database 107, request creation unit 108, response process unit 109, and API code deployment unit 110.

In operation, system 101 generates API source code by interacting with user 111 and an external system such as generative AI 112. System 101 generates requests for source code creation based on user input and sends these requests to generative AI 112. Upon receiving the API source code generated by generative AI 112, system 101 deploys this source code and sends the API endpoint to user 111. Additionally, system 101 registers the requirements received from the user 111 and the API source code in the API code creation database 107.

In detail, in response to receiving an input from user 111, system 101 uses message creation unit 103 to inquire about the type of data retrieval API user 111 wishes to generate or retrieve through the API. This may be achieved by generating and communicating a suitable message to user 111, e.g., upon user 111 successfully accessing user input recognition unit 102 after a user validation process. The information about the type of data that the user wishes to retrieve through the API creation is input to requirement template selection unit 104.

Based on the data type information that requirement template selection unit 104 receives from user input recognition unit 102, requirement template selection unit 104 identifies a corresponding template from API requirement template database 105, which stores any number of templates for each data type, and inputs the corresponding template to message creation unit 103, which communicates to the requirement template to user 111.

API requirements for data retrieval received by the user are provided to both correlated API selection unit 106 and request creation unit 108. Correlated API selection unit 106 uses the API requirements to query API code creation database 107 to identify past API requirements that are similar to those provided by the user. API code creation database 107, which may be regularly updated, stores past API requirements and corresponding API source code that has been generated based on the past API requirements.

Similarity characteristics may be ascertained using any method known in the art, for example, by establishing a highly correlated relationship using weights and other statistical tools. In addition, any number of requirements may be prioritized to modify a correlation outcome, e.g., based on user-input.

The existing source code, along with the API requirements identified by correlated API selection unit are input to request creation unit 108. Request creation unit 108 generates a request for generative AI 112 to create accurate API source code based on the API requirements provided by user input recognition unit 102 and the existing, similar API requirements and their generated source codes provided by correlated API selection unit 106. Request creation unit 108 sends the request to generative AI 112 to obtain a response. Response process unit 109 stores the API requirement, corresponding API source code, and API endpoint received from generative AI 112 in API code creation database 107. Response process unit 109 further provides the API source code and the API endpoint received from generative AI 112 to API code deployment unit 110 and provides the API endpoint information to message creation unit 103.

API code deployment unit 110 deploys the API endpoint and the API source code provided by response process unit 109. Finally, in response to receiving the API endpoint from response process unit 109, message creation unit 103 communicates the API endpoint and/or the API source code to user 111.

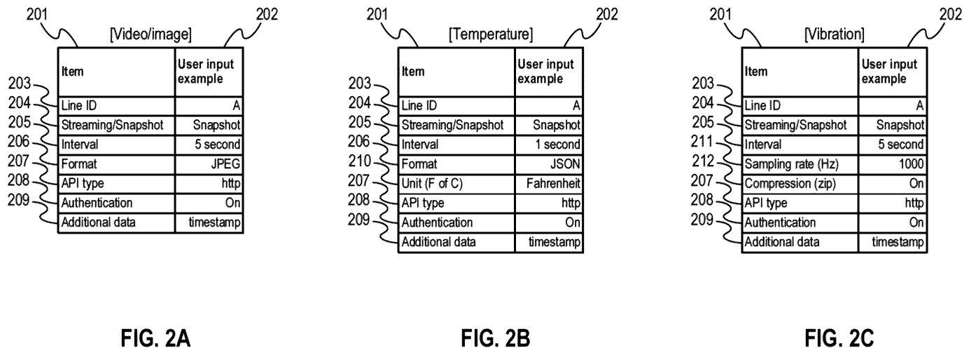

FIG. 2A through FIG. 2C illustrate exemplary API requirement templates, in accordance with an example implementation. As depicted, each template comprises an item column 201 and a user input example column 202. In embodiments, such API requirement templates are stored for data retrieval, e.g., in a database such as API requirement template database 105 in FIG. 1. FIG. 2A represents a requirement template for generating APIs to retrieve video/image data. FIG. 2B represents a requirement template for generating APIs to retrieve temperature data. FIG. 2C represents a requirement template for generating APIs to retrieve vibration data.

The requirement template in FIG. 2A comprises entries for line ID 203, streaming/snapshot 204, interval 205, format 206, API type 207, authentication 208, and additional data 209. As depicted, the requirement template in FIG. 2B comprises entries for line ID 203, streaming/snapshot 204, interval 205, format 206, unit 210, API type 207, authentication 208, and additional data 209. The requirement template in FIG. 2C comprises entries for line ID 203, streaming/snapshot 204, interval 205, sampling rate 211, compression 212, API type 207, authentication 208, and additional data 209.

Line ID 203 entries identify a production line from which data is to be retrieved. Streaming/snapshot 204 entries denote whether the data should be streamed or communicated in the form of a snapshot in time. Interval 205 entries denote a time span, e.g., in seconds, during which data is retrieved. Format 206 entries denote a data or file format, such as JPEG. API type refers to the type of the API. Authentication 208 entries indicate whether an authentication method should be applied to the APT. Additional data 209 entries may comprise information regarding metadata that is to be added to the target data. Unit 210 entries specify a unit of measure associated with the data. Sampling rate 211 entries specify the number of data points acquired per unit time. Compression 212 entries indicates whether a compression method should be applied to the data.

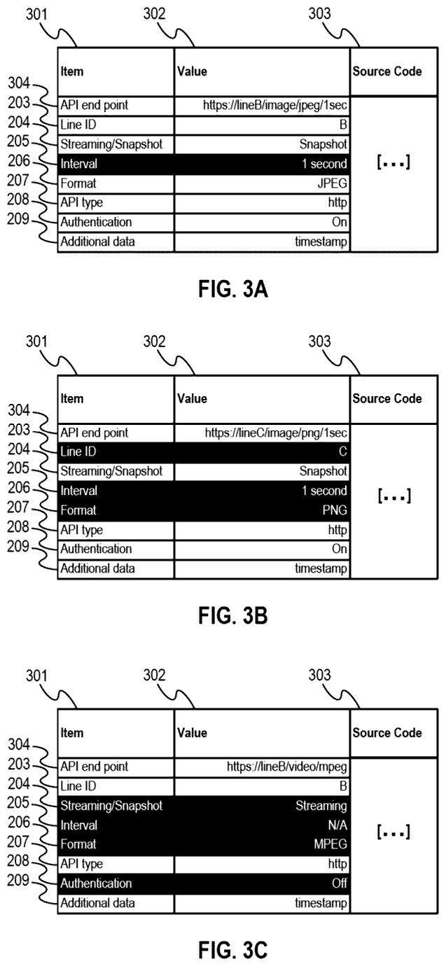

FIG. 3A through FIG. 3C illustrate exemplary records in an exemplary API code creation database, in accordance with an example implementation. In embodiments, records stored in each API code creation database in FIG. 3A through FIG. 3C may represent requirements for previously generated data retrieval APIs for video/image data, along with corresponding source code stored in each database. As depicted, records may comprise item 301 entries, value 302 entries, and source code 303. Each API endpoint 304 entry specifies a functional endpoint for accessing the stored API. As will become apparent to one of skill in the art, line ID 203 through additional data 209 entries and the source code 303 therewith are selected based on the requirement template shown in FIG. 2A.

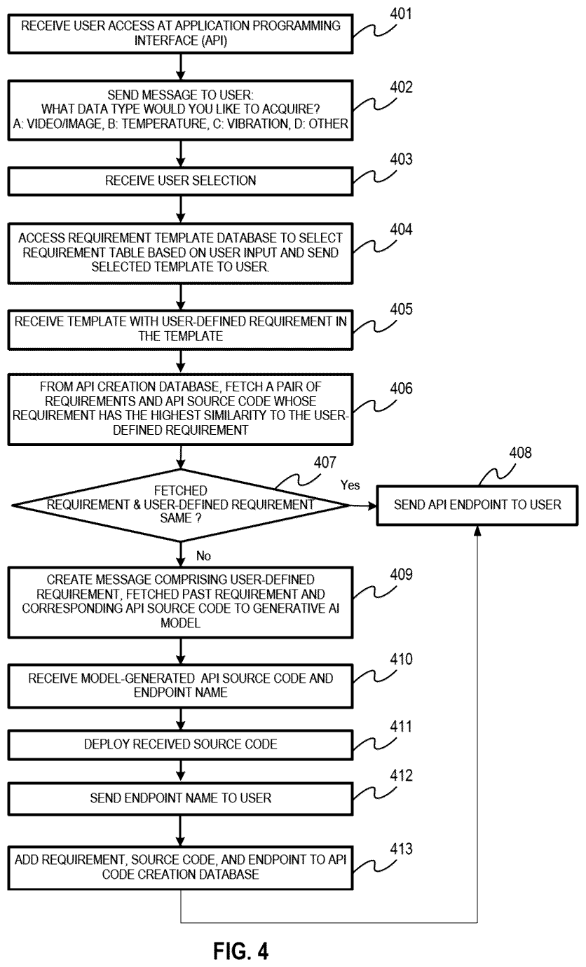

FIG. 4 is a flowchart illustrating an exemplary process for using an API source code creation system, in accordance with an example implementation. In embodiments, process 400 starts at step 401, when an API source code creation system, such as that depicted in FIG. 1, is accessed by a user. At step 402, the system communicates a message to the user to inquire about the type of data retrieval API the user requests. The user may select a type from a list of types. At step 403, the system receives the selection result from the user. At step 404, based on the user input, the system accesses a database, such as API requirement template database 105 shown in FIG. 1, to select or retrieve a suitable template among a set of stored requirement templates and communicates the selected template to the user, who provides information regarding any number of entries therein, e.g., by filling out entries in the selected template. At step 405, the system receives the user-defined requirements in the template and provides them, at step 406, to an API creation database, such as API creation database 107 shown in FIG. 1, to obtain past requirements that are most similar to the user-defined requirements and a corresponding source code that is associated with those past requirements. At step 407, the system determines whether the past requirements are the same as the user-defined requirements. If so, the process, at step 408, communicates an existing API endpoint contained in the retrieved data to the user, e.g., in the form of an endpoint vector. Otherwise, if the past requirements are not identical to the user-defined requirements, process 400 resumes with step 409.

At step 409, the system creates a message that comprises the user-defined requirements and the similar past requirements and further comprises the corresponding source that has been retrieved from the API creation database. The system sends this message to a generative AI model to instruct the model to create an API source code that satisfies the user-defined requirements. In response, the system receives, at step 410, the requested API source code and an endpoint name from the model. The system may deploy, at step 411, the received source code and communicate the endpoint name to the user, at step 412. Finally, at step 413, the system may register the user-defined requirements, the API source code obtained from the model, and the endpoint name in the API code creation database.

The following example illustrates such process 400 for using API source code creation system in which API source code is created as a result of interactions between a user and the system and between the system and a generative AI model.

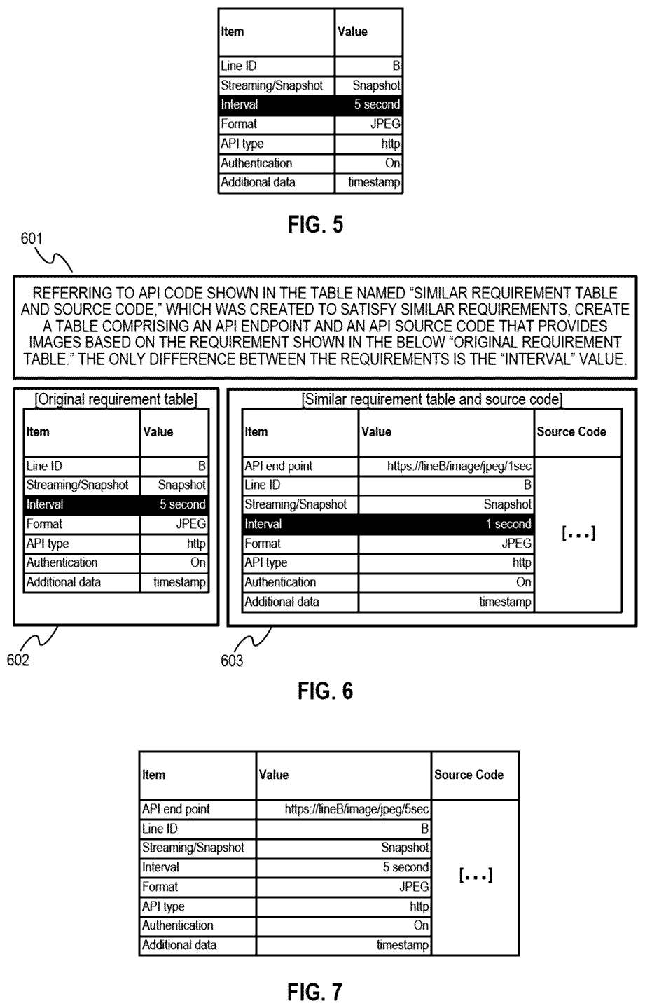

First, in response to a user accessing the API source code creation system, at step 401, and being presented with a selection such as that shown at step 402 in FIG. 4, the user may select “A: video/image.” In response to receiving the user selection at step 403, the system, at step 404, accesses a requirement template database to retrieve and send, according to the user selection, a template for video/image, such as the template shown in FIG. 2A, to the user. At step 405, the system receives user-defined requirements from the user in the form of entries that the user fills out, as illustrated in the template in FIG. 5, which depicts an exemplary table comprising user-defined requirements for an API, in accordance with an example implementation.

Assuming that the API code creation database comprises the three records of past requirements and corresponding source codes classified under video/image, as depicted in FIG. 3A through FIG. 3C, when the system compares the user-defined requirements in FIG. 5 with the past requirements in FIG. 3A, the system will find that only one item, i.e., the entry “interval” is different. In contrast, when comparing the user-defined requirements in FIG. 5 with the past requirements in FIG. 3B, the system will find that three items differ from each other. Similarly, a comparison of the current requirement with the past requirements in FIG. 3C reveals that four items differ from each other. As a result, the system will determine that the past requirements in the table in FIG. 3A are the most similar to the user-defined requirements and, accordingly, fetch table in FIG. 3A as the most similar one, at step 406. Since the requirements in the fetched table and those received by the user are not completely identical, the process will proceed to step 409 to create a message such as that shown in FIG. 6, which depicts contents of a message, in accordance with an example implementation.

The message sent from the system to the generative AI may be viewed as a query that comprises request 601, requirement table 602 for generating the API source code, and similar requirement table 603 along with its source code and a request to generate an appropriate API source code.

FIG. 7 illustrates an exemplary message generated by a generative AI module, in accordance with an example implementation. As depicted, message 700 received by the system from the generative AI, at step 410 in FIG. 4, comprises API endpoint 702 and API source code 704. At step 411, the system deploys the received source code. At step 412, the system sends the API endpoint name (denoted as https://lineB/image/jpeg/5sec in FIG. 7) to the user. Finally, at step 413, the system registers the user-defined requirements, the API source code, and the endpoint name in the API code creation database.

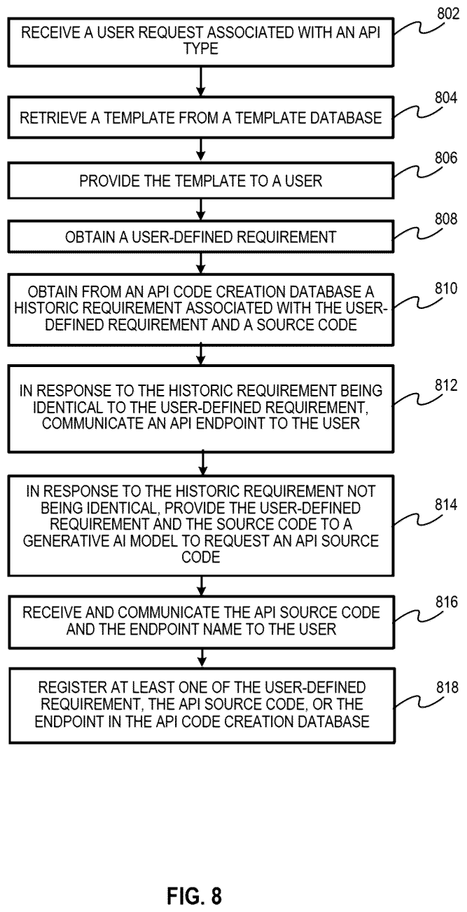

FIG. 8 is a flowchart illustrating a generalized process for using an API source code creation system, in accordance with an example implementation. In embodiments, process 800 starts at step 802, when at an API source code creation system, a user-request that is associated with an API type is received. In response, at step 804, the system retrieves a template from a template database and communicates, at step 806, the template to a user to obtain, at step 808, a user-defined requirement.

At step 810, the system then obtains from an API creation database a historic requirement associated with the user-defined requirement and further receives a corresponding source code associated with the historic requirement. At step 812, if the historic requirement is identical to the user-defined requirement, process 800 communicates an API endpoint to the user. Otherwise, at step 814, the system provides the user-defined requirement and the source code to a generative AI model to request an API source code.

In response to receiving the requested API source code and an endpoint name from the model the system, at step 816, communicates the received source code and endpoint name to the user. At step 818, the system registers at least one of the user-defined requirements, the API source code, or the endpoint name in the API code creation database. One skilled in the art shall recognize that: (1) certain steps may optionally be performed; (2) steps may not be limited to the specific order set forth herein; (3) certain steps may be performed in different orders; and (4) certain steps may be done concurrently.

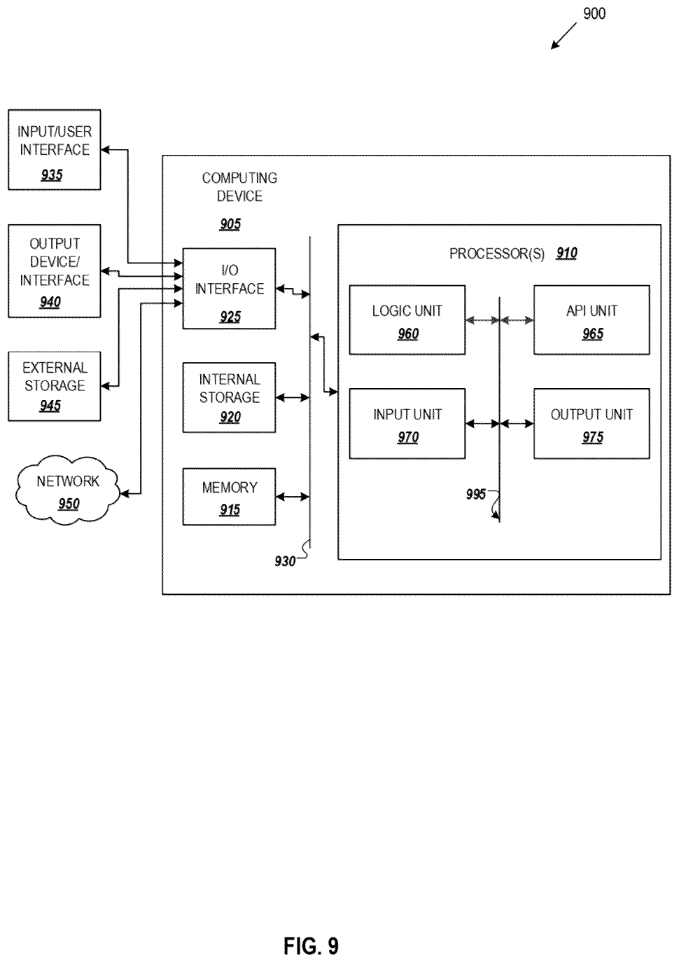

FIG. 9 illustrates an example computing environment with an example computer device suitable for use in some example implementations. Computer device 905 in computing environment 900 can include one or more processing units, cores, or processors 910, memory 915 (e.g., RAM, ROM, and/or the like), internal storage 920 (e.g., magnetic, optical, solid-state storage, and/or organic), and/or I/O interface 925, any of which can be coupled on a communication mechanism or bus 930 for communicating information or embedded in the computer device 905. I/O interface 925 is also configured to receive images from cameras or provide images to projectors or displays, depending on the desired implementation.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configurations. Computer device 905 or any connected computer device can function as, providing services of, or referred to as a server, client, thin server, general machine, special-purpose machine, or another label.

I/O interface 925 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, a satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, and output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

Processor(s) 910 can be configured to execute a method or computer instructions which can involve, in response to receiving a user request associated with an API type, retrieving a template from a template database; providing the template to a user to obtain a user-defined requirement; using the user-defined requirement to obtain from an API code creation database a historic requirement that is associated with the user-defined requirement and is associated with a source code; in response to the historic requirement being identical to the user-defined requirement, communicating an API endpoint to the user; in response to the historic requirement not being identical to the user-defined requirement, providing the user-defined requirement and the source code to a generative AI model to request an API source code; and in response to receiving the API source code and an endpoint name, communicating the endpoint name to the user, as shown, e.g., in FIG. 1, FIG. 4, and FIG. 8.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for automatic source code generation, the method comprising:
in response to receiving a user request associated with an Application Programming Interface (API) type, retrieving a template from a template database;
providing the template to a user to obtain a user-defined requirement;
using the user-defined requirement to obtain from an API code creation database a historic requirement that is associated with the user-defined requirement and is associated with a source code;
in response to the historic requirement being identical to the user-defined requirement, communicating an API endpoint to the user;
in response to the historic requirement not being identical to the user-defined requirement, providing the user-defined requirement and the source code to a generative Artificial Intelligence (AI) model to request an API source code; and
in response to receiving the API source code and an endpoint name, communicating the endpoint name to the user.

2. The method according to claim 1, further comprising registering at least one of the user-defined requirement, the API source code, or the API endpoint in the API code creation database.

3. The method according to claim 1, wherein the API type is a data retrieval API and the API endpoint is a functional API endpoint.

4. The method according to claim 1, wherein the historic requirement has been selected based on at least one of a similarity characteristic or a priority associated with the user-defined requirement.

5. The method according to claim 1, further comprising updating the template based on the user-defined requirement.

6. The method according to claim 1, further comprising updating at least one of the API code creation database or the generative AI model with a requirement-source code pair.

7. The method according to claim 1, further comprising analyzing the source code to determine whether the user-defined requirement is associated with the source code.

8. A system for automatic source code generation, the system comprising:
a user interface configured to receive a user request associated with an Application Programming Interface (API) type;
a template database configured to store a template that is provided to a user to obtain a user-defined requirement;
an API code creation database configured to provide, in response to receiving the user-defined requirement, a historic requirement associated with a historic source code and provides the user-defined requirement; and
a generative Artificial Intelligence (AI) model configured to generate, in response to receiving the user-defined requirement and the historic source code, an API source code that the system provides to the user.

9. The system according to claim 8, wherein the system further comprises a message creation unit configured to communicate a query to the user interface to obtain a query result.

10. The system according to claim 9, wherein the message creation unit is configured to communicate an endpoint name to the user in response to receiving the API source code and the endpoint name.

11. The system according to claim 9, wherein the system further comprises a response process unit configured to communicate the API source code to the message creation unit.

12. The system according to claim 9, wherein the system further comprises a template selection unit configured to use the query result to select the template from the template database.

13. The system according to claim 8, wherein the system, in response to the historic requirement being identical to the user-defined requirement, communicates an API endpoint to the user interface.

14. The system according to claim 8, wherein the generative AI model is configured to receive the user-defined requirement and the historic source code in response to the historic requirement not being identical to the user-defined requirement.

15. The system according to claim 8, wherein the API code creation database is configured to register at least one of the user-defined requirement, the API source code, or the API endpoint in the API code creation database.

16. The system according to claim 8, wherein the API type is a data retrieval API, and the API endpoint is a functional API endpoint.

17. The system according to claim 8, wherein the historic requirement has been selected based on at least one of a similarity characteristic or a priority associated with the user-defined requirement.

18. The system according to claim 8, wherein the template is updated based on the user-defined requirement.

19. A non-transitory computer-readable medium for storing instructions for executing a process, the instructions comprising:
in response to receiving a user request associated with an Application Programming Interface (API) type, retrieving a template from a template database;
providing the template to a user to obtain a user-defined requirement;
using the user-defined requirement to obtain from an API code creation database a historic requirement that is associated with the user-defined requirement and is associated with a source code;
in response to the historic requirement being identical to the user-defined requirement, communicating an API endpoint to the user;
in response to the historic requirement not being identical to the user-defined requirement, providing the user-defined requirement and the source code to a generative Artificial Intelligence (AI) model to request an API source code; and
in response to receiving the API source code and an endpoint name, communicating the endpoint name to the user.

20. The non-transitory computer-readable medium of claim 19, further comprising registering at least one of the user-defined requirement, the API source code, or the API endpoint in the API code creation database.
